(19) United States
(12) Patent Application Publication
(10) Pub. No.: US 2014/0222296 A1
(43) Pub. Date: Aug. 7, 2014

(54) VEHICLE CONTROL SYSTEM

(71) Applicants: Keisuke Takeuchi, Susono-shi (JP); Yoji Kanehara, Nagoya-shi (JP); Toshio Tanahashi, Susono-shi (JP); Yoshimitsu Agata, Numazu-shi (JP); Tomohide Kawasaki, Mishima-shi (JP)

(72) Inventors: Keisuke Takeuchi, Susono-shi (JP); Yoji Kanehara, Nagoya-shi (JP); Toshio Tanahashi, Susono-shi (JP); Yoshimitsu Agata, Numazu-shi (JP); Tomohide Kawasaki, Mishima-shi (JP)

(73) Assignee: TOYOTA JIDOSHA KABUSHIKI KAISHA, Toyota-shi (JP)

(21) Appl. No.: 13/499,576

(22) PCT Filed: Jul. 20, 2011
(86) PCT No.: PCT/JP2011/066423

§ 371 Date: Apr. 25, 2012

(51) Int. Cl. B60W 40/09; B60W 50/08

(52) U.S. Cl. CPC B60W 40/09; B60W 50/082; B60W 2540/30
USPC 701/48

(57) ABSTRACT

A vehicle control system vehicle control system configured to adjust a control characteristic of a vehicle in accordance with a driving preference of a driver. The vehicle control system detects an intentional operation of the driver based on a pattern of a change in a speed of an operation carried out by the driver to change a driving condition of the vehicle, and judges the driving preference on the basis of: a correlation of operational preference determining a correlation among an operating amount, an operating time and an operating preference; an operating amount of the intentional operation; and an operating time of the intentional operation. Therefore, the driving preference can be judged immediately when the driver carries out an operation to change a driving condition of the vehicle based on the operating time and the operating amount. The judged driving preference is reflected on the control characteristic of the vehicle immediately.

### TECHNICAL FIELD

The present invention relates to a control system for a vehicle, which is configured to adjust control characteristics of a driving force and a steering to conform to a preference of a driver (i.e., driver's disposition or intension), and especially to a system configured to detect or judge the driving preference of the driver accurately.

### BACKGROUND ART

As well known in the art, a speed of a vehicle is changed by an accelerating or decelerating operation of a driver, and a driving orientation of the vehicle is changed by rotating a steering wheel. If a change in a behavior of the vehicle matches to such operation of the driver, the driver can drive the vehicle as intended so that the driver is allowed to drive the vehicle comfortably. As a result, a drivability of the vehicle is improved. However, every driver has a different driving preference, and a driving condition is changed depending on traffic, a width of a road, a curvature of the road etc. Meanwhile, control characteristics of the vehicle are set in advance during a designing or manufacturing process. Therefore, conventional vehicles may not achieve a performance intended by the driver as it is.

Control characteristics of the conventional vehicles can be changed electrically. Therefore, according to the prior art, it has been attempted to adjust the control characteristics of the vehicle to a driving preference of the driver detected or judged while the vehicle is running. In order to carry out the adjustment of the control characteristics of the vehicle to the driver's intention, a detection or judgment of the driving preference of the driver may be carried out in various manners. For example, Japanese Patent Laid-Open No. 2007-132465 discloses a control device for enhancing a sportiveness of a vehicle based on a change in an opening degree of an accelerator. According to the teachings of Japanese Patent Laid-Open No. 2007-132465, specifically, an operation potential is calculated based on an accelerator opening degree and an operation speed thereof. A number of times the operation potential thus calculated exceeds a potential threshold value is counted, and if a count value of the operation potential exceeds a count threshold value, a learning is performed by moving the driver intension level in the sport direction.

However, the driver may not always operate the accelerator intentionally but sometimes operate the accelerator unconsciously. Therefore, if the operation of the accelerator carried out unconsciously is used to detect or judge the driving preference of the driver, an accuracy of the judgment has to be degraded. Japanese Patent Laid-Open No. 06-26377 discloses a vehicle control device configured to detect an unconscious operation of the accelerator. According to the teachings of Japanese Patent Laid-Open No. 06-26377, the operation of the accelerator is judged as an unconsciously operation in case a speed to operate the accelerator is slow, and an opening degree of the accelerator is close to that of the case in which the vehicle is running at a constant speed.

Thus, the above-explained control devices taught by Japanese Patent Laid-Open Nos. 2007-132465 and 06-26377 are configured to judge an intention of the operation of the accelerator or to judge an existence of an intention to operate the accelerator, based on the opening degree of the accelerator or a change rate thereof. Therefore, those conventional control devices are capable of detecting or judging the intention of the driver in case the accelerator is operated. However, the intention of the driver regarding a drive feeling and vehicle behavior cannot be detected or judged by those conventional control devices in case another kind of operation to change driving characteristics of the vehicle is carried out. In addition, according to the teachings of Japanese Patent Laid-Open No. 2007-132465, the operation potential obtained based on the speed or degrees of the accelerator operation carried out in the past has to be integrated plural times. This means that the control device taught by Japanese Patent Laid-Open No. 2007-132465 is incapable of detecting or judging the driver's intention until the accelerator operation is carried out multiple times, even if the single accelerator operation represents the driver's intention obviously. That is, the driver's intention cannot be detected or judged until multiple times of the accelerator operations have been carried out to wait the operation potential exceeds the threshold. Therefore, the driver's intention is delayed to be reflected on the driving characteristic of the vehicle. As a result, the driver may feel uncomfortable feeling.

Meanwhile, according to the teachings of Japanese Patent Laid-Open No. 06-26377, the vehicle control device is configured to detect an unconscious operation of the accelerator. Therefore, the control device taught by Japanese Patent Laid-Open No. 06-26377 is incapable of reflecting the intension of the driver on the driving characteristics of the vehicle.

### DISCLOSURE OF THE INVENTION

The present invention has been conceived noting the technical problems thus far described, and its object is to provide a vehicle control system capable of judging a driving preference of a driver to be reflected on control characteristics of the vehicle promptly and accurately.

In order to achieve the above-mentioned object, according to the present invention, there is provided a vehicle control system which is configured to adjust a control characteristic of a vehicle in accordance with a driving preference of a driver. Specifically, the vehicle control system is configured to detect an intentional operation of the driver based on a pattern of a change in a speed of an operation carried out by the driver to change a driving condition of the vehicle, and to judge the driving preference on the basis of: a correlation of operational preference determining a correlation among an operating amount, an operating time and an operating preference in advance; an operating amount of the intentional operation; and an operating time of the intentional operation.

Specifically, the above-mentioned correlation of operational preference among the operating amount, the operating time and the operating preference is formulated using a formulation according to Fitts's law.

The above-mentioned control characteristic includes a sporty characteristic for changing a behavior of the vehicle quickly when the driver carries out the operation, and a mild characteristic for changing the behavior of the vehicle milder in comparison with the change in the vehicle behavior under the sporty characteristic. According to the present invention, the vehicle control system comprises a means adapted to set an index which enhances sportiness of the control characteristic in case an absolute value of synthesized acceleration of at least longitudinal acceleration and lateral acceleration is large, in comparison with a case in which the absolute value of the synthesized acceleration is small. Specifically, the index is changed in a manner to enhance the sportiness in case the absolute value of the synthesized acceleration is increased, and maintained to a current value thereof until a satisfaction of a predetermined condition in case the absolute value of the synthesized acceleration is lowered. The vehicle control system further comprises a means adapted to change the aforementioned predetermined condition based on the driving preference which is judged based on the pattern of a change in the speed of the intentional operation.

According to the present invention, specifically, the predetermined condition is prevented from being satisfied in case the driving preference judged based on the pattern of a change in the speed of the intentional operation shows a tendency conforming to a behavior of the vehicle under the sporty characteristic. To the contrary, the predetermined condition is facilitated to be satisfied in case the driving preference judged based on the pattern of a change in the speed of the intentional operation shows a tendency conforming to a behavior of the vehicle under the mild characteristic.

The above-mentioned control characteristic includes at least any one of a characteristic to change a driving force based on an accelerating operation or a decelerating operation of the vehicle, and a characteristic to change a turning angle based on a steering operation.

In case the driver caries out some sort of operation intentionally or on purpose, a change in an operating speed indicates a specific pattern. Therefore, the vehicle control system according to the present invention is configured to detect an operation of the driver carried out intentionally to change a driving condition of the vehicle, based on the pattern of a change in the speed of the operation. However, in case the intentional operation is carried out, a relation between an operating time and an operating amount is changed depending on an operating preference of the driver. For example, such relation can be grasped utilizing the Fitts's law. According to the present invention, therefore, the above-mentioned relation is determined in advance, and the relation thus determined is used to obtain the operating preference, that is, a driving preference of the driver based on the operating time and the operating amount of the intentional operation of the driver, which is detected based on the pattern of a change in the operating speed. For this reason, according to the vehicle control system of the present invention, the driving preference of the driver can be detected or judged immediately when the driver carries out the intentional operation, and the control characteristic is adjusted to be conformed to the detected driving preference. Thus, according to the present invention, the driving preference of the driver can be reflected on the control characteristic of the vehicle accurately without delay.

In addition, according to the present invention, the driving preference thus judged or detected can be used to adjust the control characteristic of the vehicle between the sporty characteristic for enhancing a quickness of the vehicle behavior and the mild characteristic for changing the behavior of the vehicle in a mild manner. As described, the index used to change the sportiness of the vehicle behavior is determined based on the synthesized acceleration, and the condition for lowering the index to achieve the mild characteristic can be changed based on the detected driving preference. Therefore, the driving preference can be reflected on the control characteristic more accurately.

### BRIEF DESCRIPTION OF THE DRAWINGS

FIG. 1 is a flowchart explaining a control example carried out by the vehicle control system according to the present invention.

FIG. 2 is a flowchart explaining another control example carried out by the vehicle control system according to the present invention.

FIG. 3 is a flowchart explaining still another control example carried out by the vehicle control system according to the present invention.

FIG. 4 is a friction circle plotting detected value of longitudinal acceleration and lateral acceleration.

FIG. 5 is a graph indicating an example of a change in the command SPI according to a change in an instant SPI.

FIG. 6 is a graph indicating the integral of the deviation between the command SPI and the instant SPI, and a reset of the integral.

FIG. 7 is a flowchart explaining a control example to apply the present invention to a system for controlling the control characteristic using the synthesized acceleration.

FIG. 8 is a flowchart explaining a control example to lower a command SPI.

FIG. 9 is a view schematically showing a vehicle to which the present invention is applied.

FIG. 10 is a graph schematically showing a change in the operating speed to move a predetermined handling device in a transverse direction.

FIG. 11 is a flowchart explaining a control example to extract data about the bell-shaped wave pattern from the wave pattern of the change in the operating speed.

FIG. 12 is a view schematically showing one of the conditions for judging the bell-shaped wave pattern.

FIG. 13 is a view schematically showing another condition for judging the bell-shaped wave pattern.

FIG. 14 is a view schematically showing still another condition for judging the bell-shaped wave pattern.

FIG. 15 is a view schematically showing still another condition for judging the bell-shaped wave pattern.

FIG. 16 is a view schematically showing a fifth condition for judging the bell-shaped wave pattern.

FIG. 17 is an example of a map determining a correlation among the operating time, the operating amount and the operating preference.

### BEST MODE FOR CARRYING OUT THE INVENTION

Next, an example of the present invention will be explained hereinafter. Specifically, the vehicle control system is applied to a vehicle using an engine or a motor as a prime mover, and the vehicle is configured to change a speed and a traveling direction thereof by operating predetermined handling devices by a driver. FIG. 9 is a block diagram showing an example of the vehicle. As shown in FIG. 9, a vehicle 1 is provided with a pair of front wheels 2 and a pair of rear wheels 3. Specifically, each of the front wheel 2 serve as steering wheels, and each of the rear wheel 3 serves as driven wheels. Those wheels 2 and 3 are individually attached to a not shown vehicle body via a suspension 4. The suspension 4 is a conventional suspension device composed mainly of a not shown spring and a shock absorber (i.e., a damper) 5. The shock absorber 5 shown in FIG. 9 is configured to absorb a shock utilizing a flow resistance of air or liquid, and the flow resistance therein can be increased and decreased by a motor 6 functioning as an actuator. For example, in case of increasing the flow resistance in the shock absorber 5, a hardness of the suspension 4 is enhanced so that the vehicle 1 becomes difficult to be depressed. As a result, the drive feeling of the vehicle 1 becomes much sporty rather than comfortable. In addition, a height of the vehicle 1 can be adjusted by adjusting pressurized air in the shock absorber 5.

Although not especially shown in FIG. 9, the front and rear wheels 2 and 3 are provided individually with a brake mechanism. Those brake mechanisms are actuated to apply braking force to the wheels 2 and 3 by depressing a brake pedal 7 arranged in a driver seat.

A conventional internal combustion engine, a motor, a combination of the engine and the motor and so on may be used as a prime mover of the vehicle 1, and in the example shown in FIG. 9, an internal combustion engine 8 is used as the prime mover. As shown in FIG. 9, a throttle valve 10 for controlling air intake is arranged in an intake pipe 9 of the engine 8. Specifically, the throttle valve 10 is an electronic throttle valve, which is opened and closed by an actuator 11 such as a motor controlled electrically. The actuator 11 is actuated in accordance with a depression of an accelerator pedal 12 arranged in the driver seat, that is, in accordance with an opening degree of an accelerator, thereby adjusting an opening degree of the throttle valve 10 to a predetermined angle.

A relation between an opening degree of the accelerator such as a depression of the accelerator pedal 12 and an opening degree of the throttle valve 10 may be adjusted arbitrarily, and if a ratio of the opening degree of the accelerator to the opening degree of the throttle valve 10 is set approximately one to one, the throttle valve 10 reacts directly to the operation of the accelerator so that the sportiness of the vehicle 1 is enhanced. To the contrary, in case of reducing the opening degree of the throttle valve 10 relatively with respect to the opening degree of the accelerator, the drive feeling of the vehicle 1 is moderated. In case of using the motor as the prime mover, a current control device such as an inverter or a converter is used instead of the throttle valve 10. In this case, a relation between the opening degree of the accelerator and a current value determining characteristics of acceleration and behavior of the vehicle 1 is changed arbitrarily by adjusting the current in accordance with the opening degree of the accelerator by the current control device.

In the example shown in FIG. 9, a transmission 13 is connected with an output side of the engine 8. The transmission 13 is configured to change a speed change ratio between an input speed and an output speed arbitrarily. For example, a conventional automatic geared transmission, a belt-type continuously variable transmission, a toroidal type transmission may be used in the vehicle 1. Specifically, the transmission 13 is provided with a not shown actuator, and configured to change the speed change ratio thereof stepwise or continuously by controlling the actuator. Basically, the transmission 13 is controlled to optimize the speed change ratio in a manner to improve fuel economy. For this purpose, a speed change map for determining the speed change ratio according to a speed of the vehicle 1 and the opening degree of the accelerator is prepared in advance, and the speed change operation of the transmission 13 is carried out with reference to the map. Alternatively, the speed change ratio of the transmission 13 can be optimized by calculating a target output on the basis of the speed of the vehicle 1 and the opening degree of the accelerator, calculating a target engine speed on the basis of the calculated target output and an optimum fuel curve, and carrying out a speed change operation to achieve the obtained target engine speed.

In addition, a transmission mechanism such as a torque converter having a lockup clutch may be arranged between the engine 8 and the transmission 13 according to need. An output shaft of the transmission 13 is connected with the rear wheels 3 via a differential gear 14 functioning as a final reducing mechanism.

Here will be explained a steering mechanism 15 for changing an orientation of the front wheels 2. The steering mechanism 15 comprises: a steering wheel 16; a steering linkage 17 configured to transmit a rotation of the steering wheel 16 to the front wheels 2; and an assist mechanism 18 configured to assist a steering angle and a steering force of the steering wheel 16. The assist mechanism 18 is provided with a not shown actuator, and configured to control an assisting amount of the actuator. Therefore, a ratio of the steering angle of the steering wheel 16 to an actual steering angle of the front wheels 2 can be approximated to one to one by reducing the assisting force of the assist mechanism 18. As a result, the front wheels 2 can be turned directly in response to the rotation of the steering wheel 16 so that the sportiness of the vehicle 1 is enhanced.

Although not especially shown, in order to stabilize a behavior and attitude of the vehicle 1, the vehicle 1 is further provided with an antilock brake system (abbreviated as ABS), a traction control system, and a vehicle stability control system (abbreviated as VSC) for controlling those systems integrally. Those systems are known in the art, and adapted to stabilize the behavior of the vehicle 1 by preventing a locking and slippage of the wheels 2 and 3. For this purpose, those systems are configured to control a braking force applied to the wheels 2 and 3 on the basis of a deviation between a vehicle speed and a wheel speed while controlling the engine torque. In addition, the vehicle 1 may be provided with a navigation system for obtaining data on road information and a contemplated route (i.e., data on driving environment), and a mode selecting switch for selecting a drive mode manually from a sporty mode (i.e., sport D), a normal mode (i.e., normal D), an energy saving mode (i.e., economy mode) and so on. Further, a 4-wheel-drive mechanism (4WD) configured to change the driving characteristics such as a hill-climbing ability, acceleration, a turning ability and so on may also be arranged in the vehicle 1.

In order to obtain data for controlling the engine 8, the transmission 13, the shock absorber 5 of the suspension 4, the assist mechanism 18, and the above-explained not shown systems, various kinds of sensors are arranged in the vehicle 1. For example, a wheel speed detection sensor 19 adapted to detect a rotational speed of each wheel 2 and 3, an accelerator sensor 20 adapted to detect an opening degree of the accelerator, a throttle sensor 21 adapted to detect an opening degree of the throttle valve 10, an engine speed sensor 22 adapted to detect a speed of the engine 8, an output speed sensor 23 adapted to detect an output speed of the transmission 13, a steering angle sensor 24, a longitudinal acceleration sensor 25 adapted to detect the longitudinal acceleration (Gx), a lateral acceleration sensor 26 adapted to detect the lateral (or transverse) acceleration (Gy), a yaw rate sensor 27 and so on are arranged in the vehicle 1. Here, acceleration sensors used in the above-explained behavior control systems such as the antilock brake system (ABS) and a vehicle stability control system (VSC) may be used as the acceleration sensors 25 and 26, and if an air-bag is arranged in the vehicle 1, acceleration sensors for controlling an actuation of the air-bag may also be used as the acceleration sensors 25 and 26. Detection signals (i.e., data) of those sensors 19 to 27 are transmitted to an electronic control unit (abbreviated as ECU) 28. The ECU 28 is configured to carry out a calculation on the basis of the data inputted thereto and data and programs stored in advance, and to output a calculation result to the above-explained systems or the actuators thereof in the form of a control command signal.

The vehicle control system according to the present invention is configured to set a predetermined control characteristic in a manner to adjust a behavior of the vehicle 1 to a driving preference of the driver. For example, the driving preference may be categorized into a sporty preference to drive the vehicle agilely, a mild preference to drive the vehicle in a mild manner, and a normal preference to drive the vehicle in a manner between the sporty preference and the mild preference. Meanwhile, the control characteristics include: a characteristic of the driving force governed by a relation between an operation of the accelerator and a resultant driving force; a characteristic of the steering governed by a relation between a steering angle and a resultant yaw rate or turning angle; and a characteristic of the suspension governed by a hardness or softness to sustain the vehicle by the suspension mechanism, and so on. The driving characteristics of the vehicle can be changed to be sporty or milder by setting the above-listed control characteristics arbitrarily.

According to the present invention, the vehicle control system is configured to detect or judge the driving preference of the driver (as will be called a judgment hereinafter) based on an operating speed, an operating amount or an operating time of the predetermine handling device. Such judgment of the driving preference of the driver will be explained hereinafter.

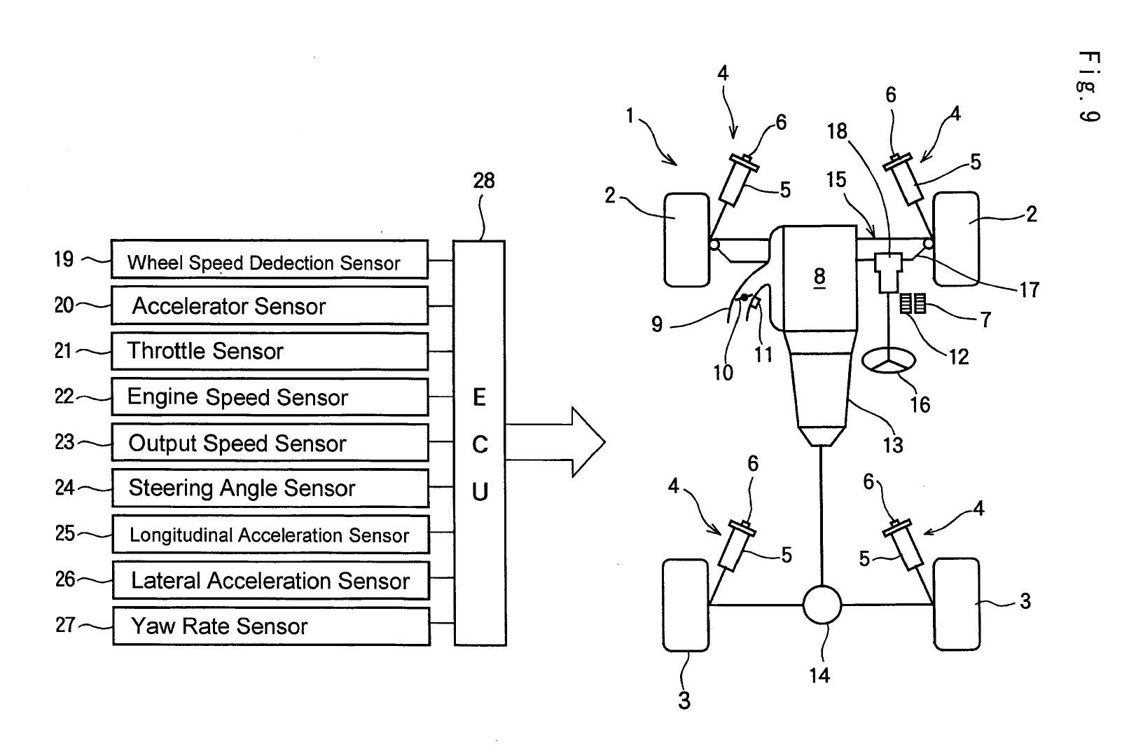

In case the driver operates some kind of handling device on purpose or intentionally, an operating speed is changed in a specific pattern from a commencement to a termination of the operation. Such change in the operating speed may be indicated by a wave pattern, and a shape of the wave is typically in a bell-shape extending toward both sides from a peak. FIG. 10 is a graph indicating a change in the operating speed of the handling device schematically, and in FIG. 10, a vertical axis represents the operating speed and a horizontal axis represents an elapsed time. Specifically, a speed of an operation of the handling device from a predetermined neutral position to a selected target position situated right or left side of the neutral position is indicated in FIG. 10. For example, such operation of the handling device can be exemplified by an operation of moving a computer mouse to move the cursor laterally on the monitor. Here, a signal from a sensor detecting the operating amount or operating speed of the handling device contains a disturbance signal resulting from an operational disturbance and vibrations of the handling device etc. Therefore, the signal representing the operating amount or operating speed of the handling device detected by the sensor is subjected to a filtering, and as a result, a curved line representing the operating speed of the handling device is converged into the wavy shape as indicated in FIG. 10.

In FIG. 10, “a” represents a first operation to move the handling device from the neutral position to a target position in the right side of the neutral position. As can be seen from the curved line representing the first operation “a”, the operating speed increases smoothly to an intermediate point on the way to the target point, and becomes fastest at the intermediate point (i.e., at a peak of the wave). The operating speed is then lowered smoothly from the peak of the wave. A second operation “b” was carried out in a direction opposite to the operation “a”. As indicated by the curved line representing the operation “b”, the operating speed is increased abruptly just after the commencement and lowered temporarily, and then, the operating speed is again increased and terminated eventually. This means that there may be a hesitation of the driver during the operation “b”. That is, the second operation “b” may be carried out to move the handling device unconsciously to an undecided point. Therefore, the second operation “b” is considered as an unintentional operation. The wave patterns of a third to sixth operations “c”, “d”, “e” and “f” are similar to that of the first operation “a”, therefore, those operation are considered as the intentional operation to the target position. However, during a seventh operation “g”, the operating speed is increased abruptly just after the commencement but takes long time to be terminated. That is, the peak of the wave is biased significantly toward the commencement of the operation. Basically, in case of moving the handling device on purpose toward a tolerable range around the target point, the handling device is moved to the target point by the most direct way so that the pattern of the wave representing the operating speed describes the above-explained bell-shape or a shape similar to the bell shape. Thus, the pattern of the wave representing the seventh operation “g” is wildly different from the bell-shape. Therefore, the seventh operation “g” cannot be considered as the operation carried out with the clear intention. Likewise, a curved line representing an eighth operation “h” indicates a local maximum operating speed during the operation “h”, however, the operating speed is then reduced merely slightly. Therefore, the eighth operation “h” is not considered as an operation to move the handling device toward the target point, but rather considered as a preliminary operation of subsequent another operation. However, as indicated by a curved line representing a ninth operation “i”, the wave pattern of the operating speed during the operation “i” is in the bell-shape. Therefore, the ninth operation “i” is considered as the intentional operation to move the handling device toward the target point. In FIG. 10, “o” represents the wave pattern of the operating speed which can be considered as an independent intentional operation, and “x” represents the wave pattern of the operating speed which cannot be considered as an independent intentional operation.

According to the present invention, the vehicle control system is configured to detect an intentional operation of the driver based on a change in (a pattern of) the operating speed, and to detect or judge a driving preference of the driver based on the detected operation. Specifically, according to the present invention, the vehicle control system is configured to detect as operating speed of an operation of the accelerator, the steering or the brake. Then, the vehicle control system judges whether or not the operation is an independent operation (as will be also called a “unit operation” hereinafter) based on a change in the detected operating speed, and judges whether or not the unit operation is carried out intentionally. If the operation is carried out intentionally, an intention of the driver is judged based on an operating amount and an operating time.

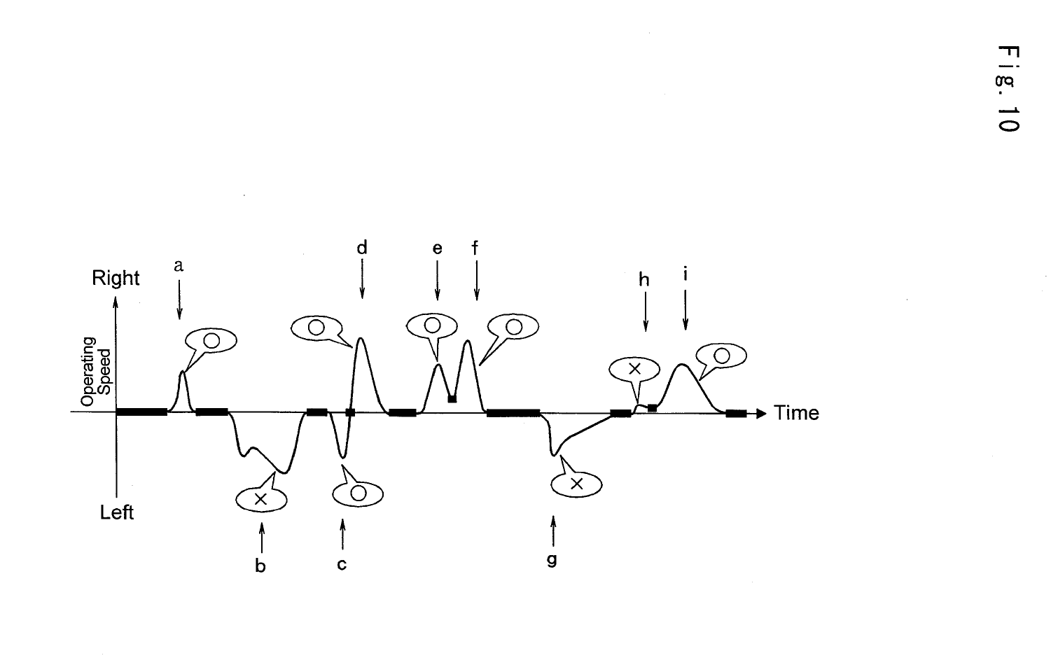

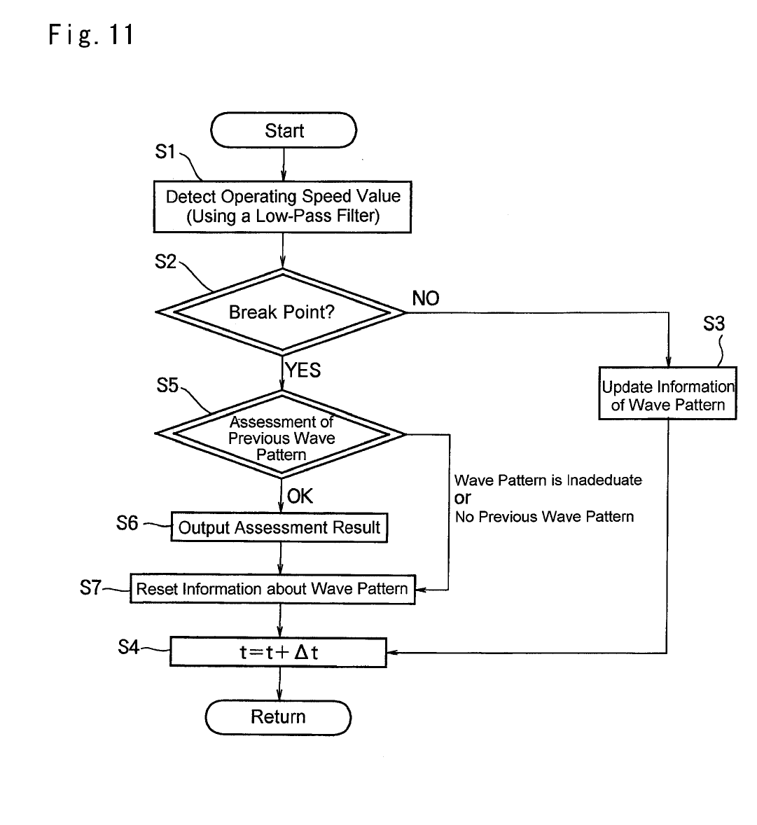

FIG. 11 is a flowchart explaining the control for detecting the unit operation carried out by the driver intentionally based on a pattern of a change in the operating speed. First of all, a value of the operating speed is detected (at step S1). Specifically, an operating speed of the handling device operated by the driver for changing a driving condition of the vehicle, that is, an operating speed of the accelerator, the steering or the brake is detected at step S1. The operating speed of each handling device can be detected by a speed sensor attached thereto. Alternatively, the operating speed of the handling device may also be obtained by differentiating a detection value of a position sensor such as an opening sensor of the accelerator and a steering sensor, or an operating amount sensor. As described, the detection signal of the operating speed may contain a disturbance signal. Therefore, in order to eliminate the disturbance signal from the detection signal of the operating speed, a filtering of the detection signal is carried out using a low-pass filter.

Then, it is judged (or recognized) whether or not the current wave pattern of the change in the operating speed is at a breakpoint (at step S2). Basically, an intentional operation is continued until the operator achieves his/her purpose, that is, an intentional operation to move the handling device to the target point is continued until the handling device is moved to the target point. Therefore, the speed of the operation carried out intentionally is always changing during the operation. Then, after the termination of the operation, the operating speed is varied from the previous value, and changed in different pattern in comparison with the wave pattern during the previous operation, until commencement of the subsequent operation. Therefore, the breakpoint of the wave pattern representing the operating speed is judges at step S2 utilizing such nature of the change in the operating speed. Such brake points are indicated by thick lines in FIG. 10.

In case the answer of step S2 is NO, information about the current wave pattern of the operating speed is updated (at step S3). Specifically, a currently maintained speed value is updated to the speed value detected at step S1, and the information about the current wave pattern of the operating speed is updated based on the speed value thus updated. Then, time information is incremented as expressed by the formula (t=t+Δt), where “t” represents a current time and “Δt” represents a cycle time to repeat the routine shown in FIG. 11 (at step S4), and the routine is returned.

The above-explained update of the information about the wave pattern at step S3 is carried out repeatedly, and an operation of the driver is commenced and terminated during the repetition of the update. After the information about the operating speed is accumulated, a predetermined wave pattern is formed based on the accumulated information. As a result, the breakpoint is formed after the termination of the operation, and the routine advances from step S2 to Step S5 (i.e., YES at S2) to carry out an assessment of the wave pattern of the change in the speed of the last operation (at step S5). Specifically, at step S5, it is judged whether or not the wave pattern of the last operation was formed as a result of the intentional unit operation, that is, it is judged whether or not the wave pattern of the last operation is in the bell-shape. Here, the judgment at step S5 is made on the basis of a satisfaction of at least one of the following conditions “A”, “B”, “C”, “D” and “D”.

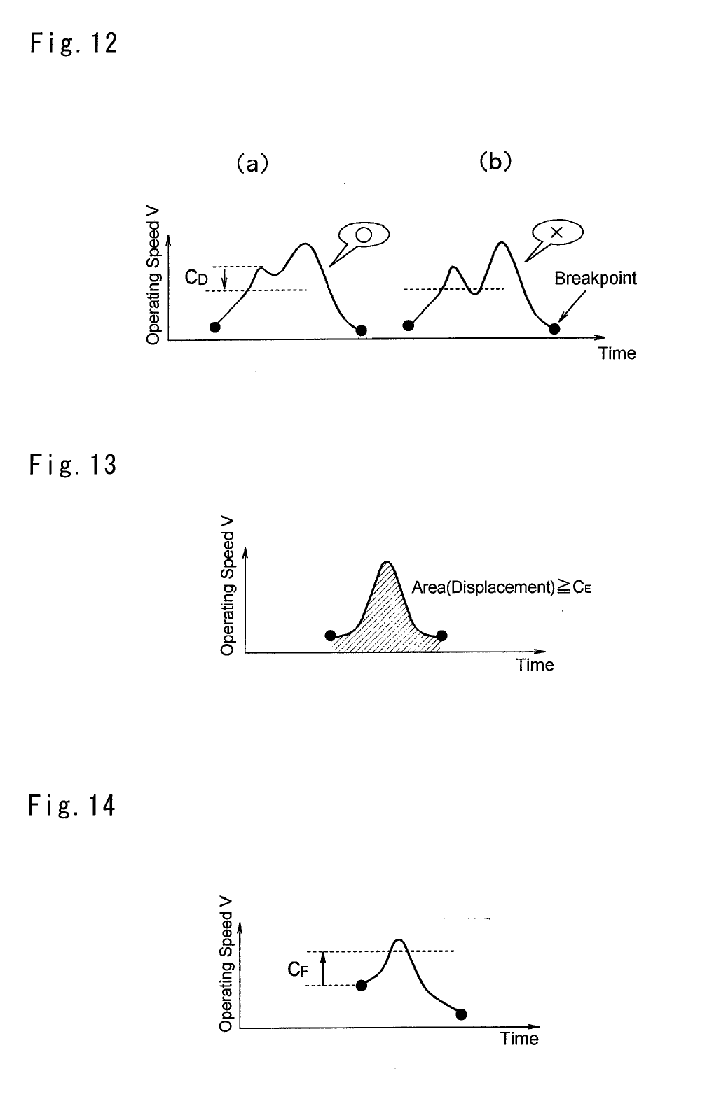

First, the condition “A” is that a drop in the operating speed larger than a predetermined speed range C_{D} (i.e., a local minimum speed or a valley) does not exist during the change in the operating speed (i.e., in the wave pattern) defined by the break point judged at step S2. The speed range C_{D} may be determined from a peak of the wave pattern defined by the break point to be wider than a drop width of the operating speed which may occur during an ordinary unit operation. FIG. 12(a) shows an example in which the operating speed does not drop beyond the speed range C_{D} as a criterion for judgment during the unit operation. In this case, the condition “A” is satisfied even if the operating speed is dropped temporarily during the unit operation. Meanwhile, FIG. 12(b) shows an example in which the operating speed drops beyond the speed range C_{D} during the unit operation. If such temporal drop of the operating speed occurs during the unit operation, the condition “A” is not satisfied.

The condition “B” is that an operating amount (i.e., a displacement) is larger than a predetermined certain value (i.e., a criterion value) C_{E}. The criterion value C_{E} is determined for each operation of the accelerator, the steering etc. Specifically, the criterion value C_{E} may be determined by reference to a minimum amount of an operation carried out by the driver to change a driving condition under the normal running condition of the vehicle. Alternatively, the criterion value C_{E} may also be determined by reference to an approximate value of a maximum amount of the unintentional operation obtained from an experimentation or simulation result. Specifically, the operating amount is expressed by a product of the operating speed and the time. Therefore, as shown in FIG. 13, the operating amount can be calculated by integrating the operating speed within the wave pattern between the break points. Alternatively, the operating amount may also be obtained based on a difference between the data of displacement detected at the starting point of the operation and the data of displacement detected at the ending point of the operation.

As schematically shown in FIG. 14, the condition “C” is that a peak value (i.e., a maximum value) of the operating speed increasing from the speed value at the larger breakpoint out of two breakpoints defining the wave pattern of the unit operation therebetween is sufficiently large, that is, the operating speed is increased to be higher than a threshold (i.e., a criterion) C_{F}. If the operating speed is not increased sufficiently after the break point, it is considered that such operation is derived continuously from the previous operation. To the contrary, if the operating speed at the subsequent breakpoint is not lowered sufficiently from the peak value, it is considered that the series of the operations is still being continued.

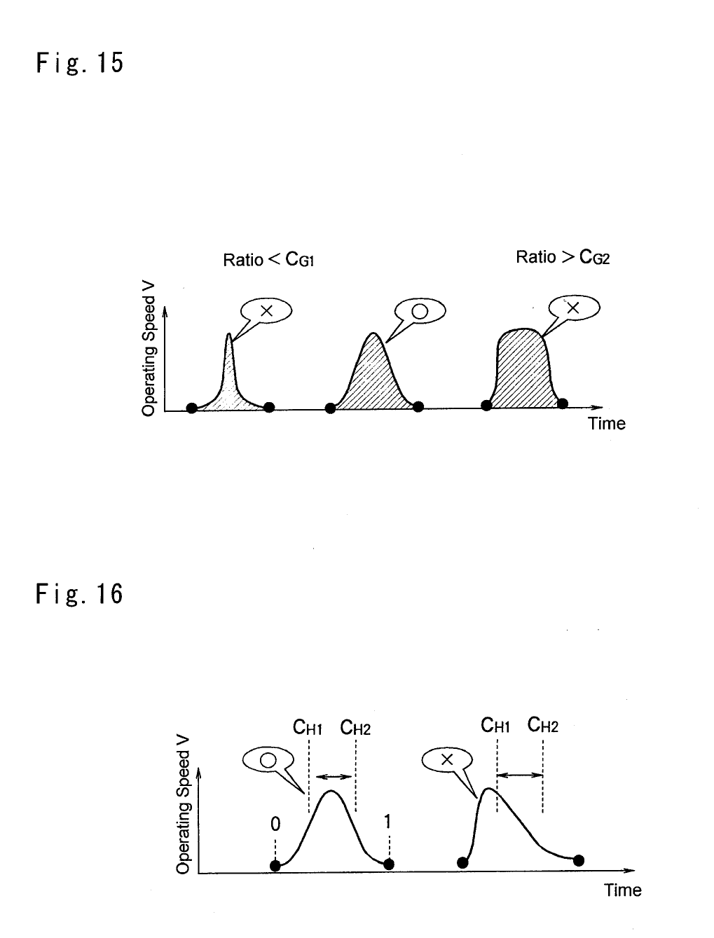

The condition “D” is that a configuration of the peak of the wave pattern is protruded moderately to be in the bell shape, and a “sharpness” thereof is within an appropriate range. FIG. 15 shows three examples of the wave pattern. In case the wave pattern shown in the left side of the FIG. 15, the operating speed is increased abruptly to the peak, and then decreased abruptly. Therefore, the peak of the wave pattern in this case is pointed sharply. To the contrary, in case the wave pattern shown in the right side of the FIG. 15, duration time of the maximum operating speed is rather long. In this case, therefore, the peak is not appeared clearly the wave pattern. However, in case the wave pattern in the middle of FIG. 15, the operating speed is increased and decreased substantially equally, and duration time of the maximum operating speed is not especially long. In this case, therefore, the peak is appeared clearly in the wave pattern but it is not too sharp. For this reason, the wave pattern in the middle of FIG. 15 can be considered as indicating the unit operation carried out by the driver intentionally, and in this case, the condition “D” is satisfied. Specifically, a satisfaction of the condition “D” can be judged based on the operating amount between the breakpoints, that is, an area enclosed by the wave pattern. For example, a satisfaction of the condition “D” is judged by comparing the area enclosed by the wave pattern with an area enclosed by a virtual square where a width between the breakpoints is a base, and a distance between the base and the peak is a height. For this purpose, a lower limit C_{G1} and an upper limit C_{G2} of a ratio of the area enclosed by the wave pattern to the area enclosed by the virtual square are determined in advance. In this case, specifically, the condition “D” is satisfied if the area enclosed by the wave pattern (i.e., the operating amount) is within a range between the lower limit C_{G1} and the upper limit C_{G2}. Therefore, only the example shown in the middle of FIG. 15 satisfies the condition “D”, and the remaining wave patterns of the right and the left sides cannot satisfy the condition “D”.

The condition “E” is that the peak of the operating speed is situated within a central region in the wave pattern between the breakpoints. In case of carrying out an intentional operation to move the handling device to the target point, the operating speed is increased to the maximum point gradually and then reduced gradually from the maximum point, as expressed by the bell-shaped or substantially bell-shaped wave pattern. In this case, the peak of the operating speed is situated at a substantially intermediate point of the bell-shaped wave pattern. That is, if the peak of the operating speed is deviated from the intermediate point and the wave pattern is therefore laterally asymmetric, the operation is considered as not being carried out under normal condition. Therefore, the fact that the peak of the operating speed is situated within the central region of the wave pattern is used to judge whether or not the operation is carried out intentionally. In this case, a predetermined time period is set in both sides of an intermediate time point between the break point defining the wave pattern, that is, between a lower limit C_{H1} of the starting point side and an upper limit C_{H2} of the ending point side, as schematically shown in FIG. 16. Therefore, in case the time point at which the operating speed is highest is situated between the lower limit C_{H1} and the upper limit C_{H2}, the condition “E” is satisfied. To the contrary, in case the time point at which the operating speed is highest is out of the range between the lower limit C_{H1} and the upper limit C_{H2}, the condition “E” is not satisfied. Specifically, in FIG. 16, “o” represents an example in which the condition “E” is satisfied, and “x” represents an example in which the condition “E” is not satisfied.

Here, it is unnecessary to judge satisfactions of all of those conditions “A” to “E” to assess the shape of the wave pattern. That is, the assessment at step S5 may be carried out by judging a satisfaction of at least one of the conditions “A” to “E”. However, an accuracy of discrimination between the intentional operation and the unintentional operation can be improved by using more conditions for the configuration assessment of the wave pattern.

Thus the assessment of shape of the wave pattern indicating the previous operation is carried out at step S5. In case the answer of step S5 is YES, that is, in case the wave pattern indicates the intentional operation of the driver carried out to change the driving condition of the vehicle in accordance with the driver's driving preference, an assessment result is outputted (at step S6). Specifically, data about the operating speed, the operating amount and the operating time of the operation indicated by the wave pattern judged as YES at step S5 is outputted. Then, a reset of the information about the shape of the wave pattern is carried out (at step S7) for the purpose of carrying out the next assessment of newly detected wave pattern. Then, the routine advances to step S4 to increment the time information as expressed by the formula (t=t+Δt), and returned.

The assessment result outputted at step S6 indicates the fact that the handling device such as the accelerator pedal or steering is operated based on the intention of the driver, while indicating the intention of the driver appeared on the operation. Therefore, the vehicle control system according to the present invention is configured to judge the driving preference of the driver based on the data about the unit operation thus detected. Specifically, the judgment of the driving preference of the driver is carried out using a principle or a low defining that the operating amount and the operating time of the unit operation bear a certain relation based on the operator's preference. Such correlation of operational preference among the operating amount, the operating time and the operating preference may be formulated in advance using Fitts's law, as expressed by the flowing formulation:

T=a·D^{x}

where T is the operating time, D is the operating amount (i.e., an operating distance), “a” stands for a constant determined according to the operating preference, and “x” stands for a constant determined based on an experimentation or a simulation.

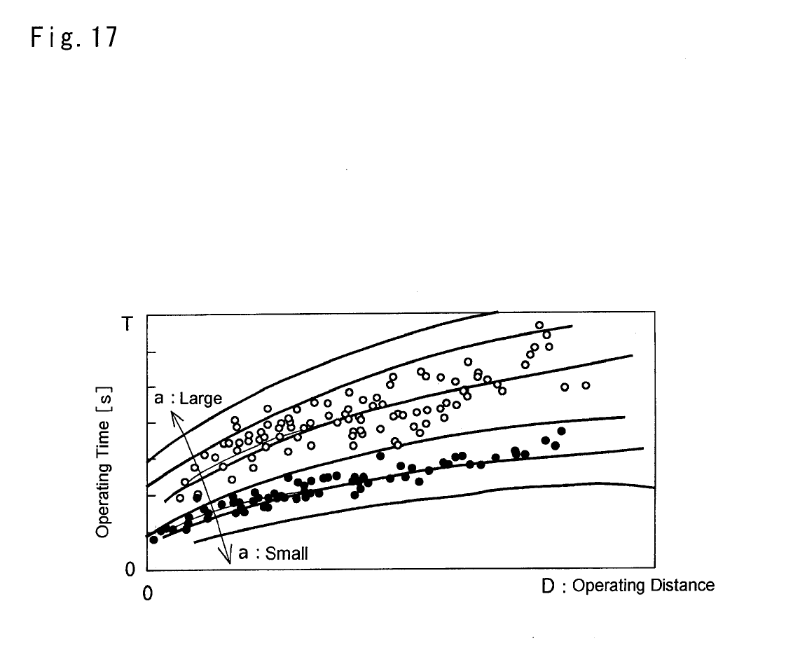

FIG. 17 is a graph plotting operating amounts and operating times of operations of the accelerator corrected from a driving test, where a horizontal axis represents the operating amount (i.e., an operating distance), and a vertical axis represents the operating time. In order to prepare FIG. 17, multiple times of the driving tests have been carried out by driving a common vehicle by a plurality of drivers in a sporty manner and in a mild manner. In FIG. 17, the black circle represents the operating amount and the operating time corrected from the driving test carried out in a sporty manner, and the white circle represents the operating amount and the operating time corrected from the driving test carried out in a mild manner. As can be seen from FIG. 17, data corrected from the driving tests in a sporty manner show a specific tendency to be concentrated in the vicinity of any one of thick lines. Also, data corrected from the driving tests in a mild manner concentrated in the vicinity of another one of thick lines in FIG. 17. That is, a curved line connecting averaged or intermediate values of the black circles, and a curved line connecting averaged or intermediate values of the white circles are approximately similar to curved lines drawn by substituting given values into the constants “a” and “x” in the above-explained formulation according to Fitts's law. In other words, the curved line representing the relation between the operating time and the operating distance of the case in which the vehicle is driven in a sporty manner, and the curved line representing the relation between the operating time and the operating distance of the case in which the vehicle is driven in a mild manner can be obtained by changing the value of the constant “a” while keeping the constant value “x” to a constant value. Thus, the operating amount, the operating time and the operating preference are subjected to Fitts's law to be correlated among each other. Therefore, the operating preference, that is, the driving preference of the driver can be judged by obtaining the constant “a” using the operating amount and the operating time detected from the actual operation as factors, with reference to the graph shown in FIG. 17 as a control map. Thus, the constant “a” represents a driving preference of the driver.

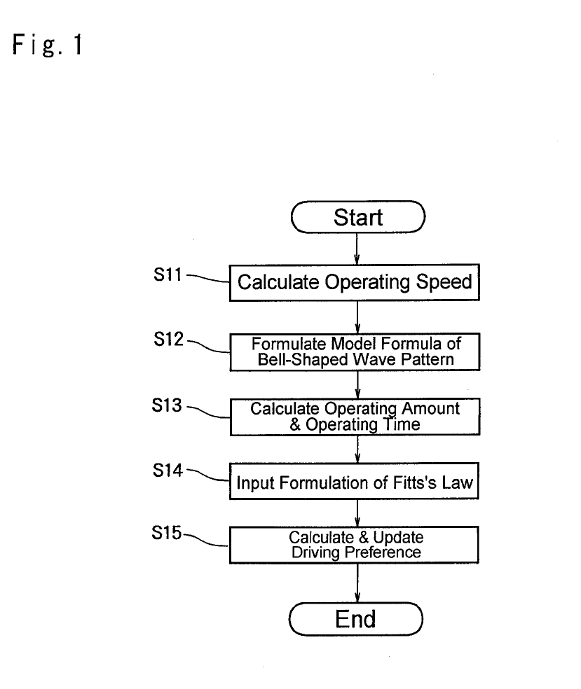

The vehicle control system according to the present invention is configured to judge the operation of the driver carried out intentionally, using the above-explained bell-shaped changing pattern of the operating speed, and the correlation among the operating amount, the operating time and the operating preference. FIG. 1 is a flowchart explaining an example to judge the intentional operation. First of all, a speed of the operation (including an absolute value thereof, the same applied hereinafter) carried out by the driver is calculated (at step S11). Specifically, the operating speed can be obtained by differentiating a detection signal from a displacement (or positional) sensor such as the accelerator opening sensor 20 or the steering angle sensor 24 with respect to time. Instead, the operating speed may also be detected using a speed censor adapted to detect the operating speed directly.

Then, a model formula of the bell-shaped wave pattern is formulated (at step S12). Specifically, the control carried out at step S12 corresponds (or is similar) to the control carried out at step S6 of the aforementioned routine shown in FIG. 11. Specifically, at step S12, data about the wave pattern representing the change in the operating speed such as the operating speed, the operating amount, the operating time etc. are detected and inputted.

Then, the operating amount and the operating time are calculated (at step S13) based on the data detected at step S12. The operating amount (or distance) thus calculated corresponds to the reference “D”, and the operating time thus calculated corresponds to the reference “T” in the above explained formulation according to Fitts's law. Meanwhile, the formulation according to Fitts's law is inputted (at step S14) in parallel with or at the same time with carrying out the calculation of step S13. The formulation may be prepared in advance by obtaining the above-explained constant (or power) “x” based on an experimental result or a simulation result. Therefore, the formulation may also be obtained with reference to the map shown in FIG. 17.

As described, the formulation (T=a·D^{x}) according to Fitts's law determines the correlation among the operating time, the operating distance and the operating (or driving) preference. Therefore, the constant “a” can be calculated by substituting the operating amount and the operating time calculated at step S13 into the formulation according to Fitts's law inputted at step S14. That is, the operating (or driving) preference of the driver is calculated and updated at step S15. Then, the routine shown in FIG. 1 is ended.

The constant “a”, that is, the driving preference of the driver is calculated immediately after a termination of the intentional operation of the driver toward a predetermined target. Therefore, the vehicle control system according to the present invention is capable of judging the driving preference of the driver promptly without delay. The driving preference of the driver thus obtained is reflected on the control of the vehicle. Therefore, the driver is allowed to drive the vehicle based on his/her intention so that the drivability of the vehicle is improved.

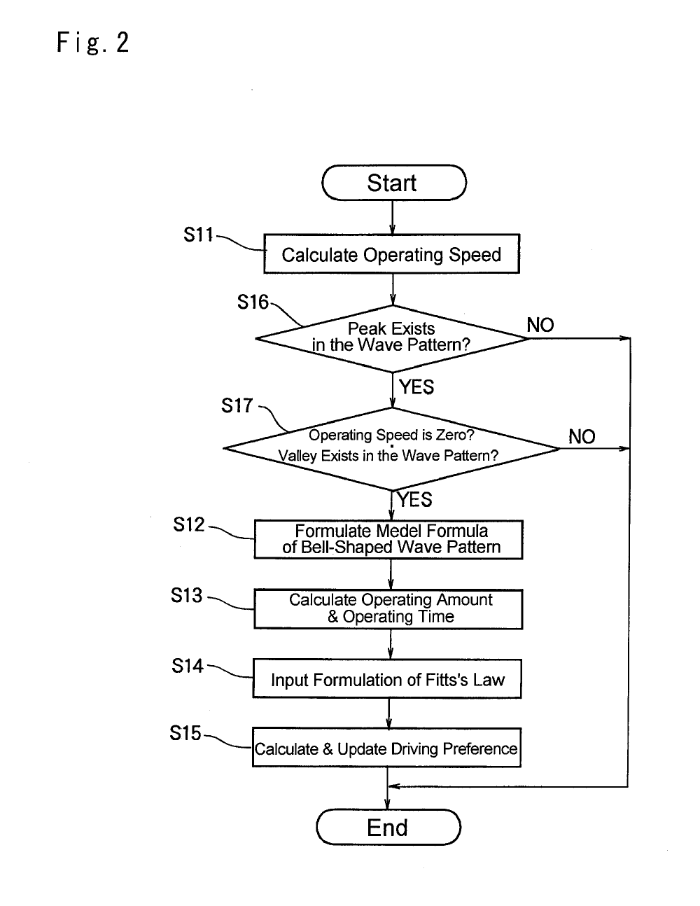

However, an unintentional operation may be carried out by the driver while driving the vehicle. Therefore, it is preferable to pick up the data for judging the intention or preference of the driver from the wave patterns of the change in the speed of the operations being carried out continuously, while avoiding the data about the operation carried out unintentionally. FIG. 2 shows a control example configured to assess a configuration of the wave pattern and to collect the data from the continuous wave patterns.

Specifically, the control example shown in FIG. 2 is configured to judge an existence of a peak in the wave pattern at which the operating speed is highest and an existence of a so-called “valley” in the wave pattern at which the operating speed is lowered or zero, and to judge the driving preference based on the judgment result of existence of the peak or valley. As shown in FIG. 2, a speed of the operation carried out by the driver is calculated (at step S11), and then, an existence of the local maximum value (i.e., a peak) in the calculated operating speed is judged (at step S16). That is, the judgment at step S16 is carried out to judge whether or not the wave patter of change in the operating speed calculated at step S11 is in the bell-shape. Specifically, the judgment of an existence of the peak is carried out by comparing the operating speed at a predetermined time point with the operating speeds of before and after the predetermine time point. In case the operating speed is being increased or lowered continuously and the peak does not exist in the wave pattern, that is, in case the answer of step S16 is NO, the routine shown in FIG. 2 is returned without carrying out any specific control.

To the contrary, in case the peak exists in the wave pattern so that the answer of step S16 is YES, it is judged whether or not the operating speed is lowered to zero, or whether or not the aforementioned “valley” exists in the wave pattern (at step S17). In case the aforementioned break point is not found in the wave pattern so that the answer of step S17 is NO, the routine shown in FIG. 2 is returned without carrying out any specific control. In order to detect the unit operation carried of the driver from the wave patterns of the change in the operating speed, the wave pattern is required to be in the bell-shape. Therefore, in addition to judge the fact that “the operating speed is zero” or the fact that “the valley exists in the wave pattern”, the shape of the wave pattern may also be judged on this occasion by judging a satisfaction of any of the above-explained conditions “A” to “E”. In this case, if the shape of the wave pattern is not in the bell-shape, the routine shown in FIG. 2 is returned. To the contrary, in case the condition to judge that the wave pattern is in the bell-shape is satisfied, the routine advances to step S12.

In case the answer of step S17 is YES, or in case answer of step S17 is YES and the wave pattern is judged as being in the bell-shape, the routine advances from the steps S12 to S15 to carry out the controls for judging the driving preference of the driver as explained with reference to FIG. 1.

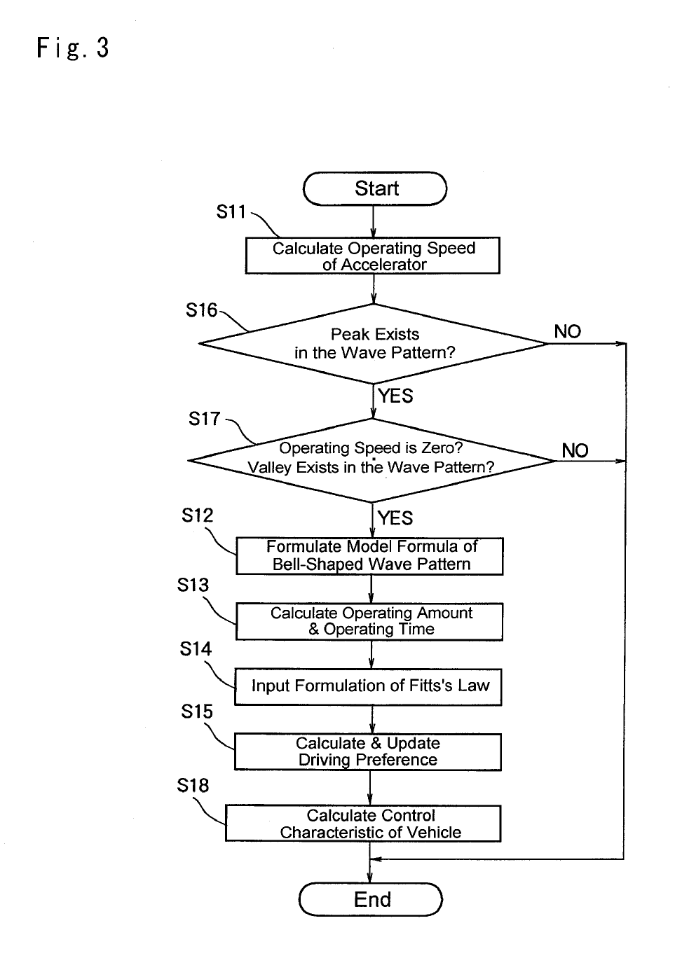

The driving preference of the driver thus judged by the above-explained control is used to adjust or correct the control characteristics of the handling devices for changing the driving condition of the vehicle, as will be explained with reference to a flowchart shown in FIG. 3. Steps S11, S16, S17, and S12 to S15 are identical to those of the flowcharts shown in FIGS. 1 and 2. According to the control example shown in FIG. 3, after calculating and updating the aforementioned constant “a”, that is, the driving preference, a control characteristic of the vehicle is calculated (at step S18). For example, the control characteristics includes: a characteristic of the driving force, which is determined depending on a relation between the operating amount of the accelerator and the control amount of the opening degree of the throttle valve or the speed change ratio; a characteristic of the suspension, which is determined depending on a relation between the operating amount of the accelerator with respect to the vehicle speed and a hardness of the suspension mechanism or a vehicle height; and a characteristic of the steering, which is determined depending on a relation between the steering angle and an angle of the steered wheels or a yaw rate to be established. Therefore, at step S18, any one of above-explained control characteristics is calculated and adjusted based on the calculated driving preference of the driver. Specifically, a control gain for changing the above-explained control characteristics is adjusted to be conformed to the driving preference of the driver. Alternatively, a correction coefficient of a control command is adjusted to adjust the control command to a value which can achieve the driving condition intended by the driver. For example, in case the driver intends to drive the vehicle in a mild manner, the control gain is reduced to a smaller value, or the correction coefficient of the control command is adjusted to reduce the control amount. To the contrary, in case the driver intends to drive the vehicle in a sporty manner, the control gain is increased to enhance the agility of the vehicle, or the correction coefficient of the control command is adjusted to increase the control amount relatively larger.

Here will be explained an example to apply the present invention to a control for adjusting the control characteristic (especially sportiness) based on acceleration of the vehicle in all directions. According to the control for adjusting the control characteristic based on an absolute value of the acceleration, a synthesized acceleration of longitudinal acceleration and lateral acceleration is used to control the sportiness of the vehicle. For example, in case the synthesized acceleration is increased to be larger than the previous value, a value of an index representing the sportiness is increased to enhance the sportiness. To the contrary, in case the synthesized acceleration is reduced, the index is kept to the previous value until a predetermined condition is satisfied, and the index is then lowered to reduce the sportiness upon satisfaction of the predetermined condition. Specifically, the vehicle control system according to the present invention can be applied to the control to lower the index.

The synthesized acceleration is used to calculate the index representing the sportiness in each moment as expressed by the following formula:

Instant SPI=(Gx²+Gy²)^{1/2}

where Instant SPI is an abbreviation of “Instant Sportiness Index” representing the sportiness in each moment, Gx represents the longitudinal acceleration, and Gy represents the lateral acceleration.

At least one of positive acceleration and negative acceleration (i.e., deceleration) of the longitudinal acceleration Gx is preferable to be normalized to be used in the above formula. In case of driving the vehicle, an actual negative acceleration is larger than an actual positive acceleration. However, the driver cannot sense such difference between the actual negative acceleration and the actual positive acceleration in most cases. That is, the driver is basically unable to recognize the difference between the actual negative acceleration and the actual positive acceleration. Therefore, in order to correct a gap between the actual acceleration value and the acceleration recognized by the driver, the longitudinal acceleration Gx is normalized by increasing the value of the positive acceleration, or by reducing the value of the negative acceleration. Specifically, such normalization may be carried out by obtaining a ratio between maximum values of the positive acceleration and the negative acceleration, and multiplying the obtained ratio by the value of the positive or negative acceleration. Alternatively, the value of the negative acceleration of the lateral acceleration Gy may be corrected. For example, a longitudinal driving force and a lateral force generated by a tire can be indicated in a friction circle. Likewise, the normalization is a process to maintain maximum accelerations in each direction within a circle of predetermined radius by weighting at least one of the positive and negative acceleration values. As a result of such normalization, an influence of the positive acceleration and an influence of the negative acceleration on the control to change the driving characteristics of the vehicle are differentiated.

Thus, a degree of the gap between the actual acceleration value and the acceleration sensed by the driver is different depending on the direction of the acceleration. For example, the degree of the gap between the actual acceleration value and the acceleration sensed by the driver in the yawing direction of the vehicle is different from that in the rolling direction of the vehicle. Therefore, a degree to reflect the acceleration on the control to change the driving characteristics of the vehicle, in other words, a degree to change the driving characteristics of the vehicle according to the acceleration is preferable to be differentiated depending on the direction of the acceleration.

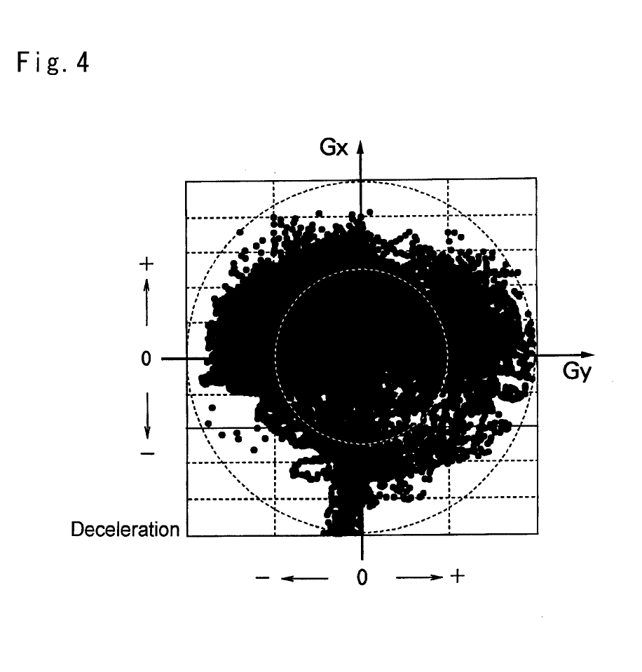

FIG. 4 is a friction circle plotting sensor values of the lateral acceleration Gy and normalized values of the longitudinal acceleration Gx. Those values indicated in FIG. 4 were collected by driving the vehicle in a test course imitating ordinary roads. As can be seen from FIG. 4, the lateral acceleration Gy is not increased frequently in case of decelerating the vehicle significantly, but a certain degree of the lateral acceleration Gy is generated generally in case of decelerating the vehicle.

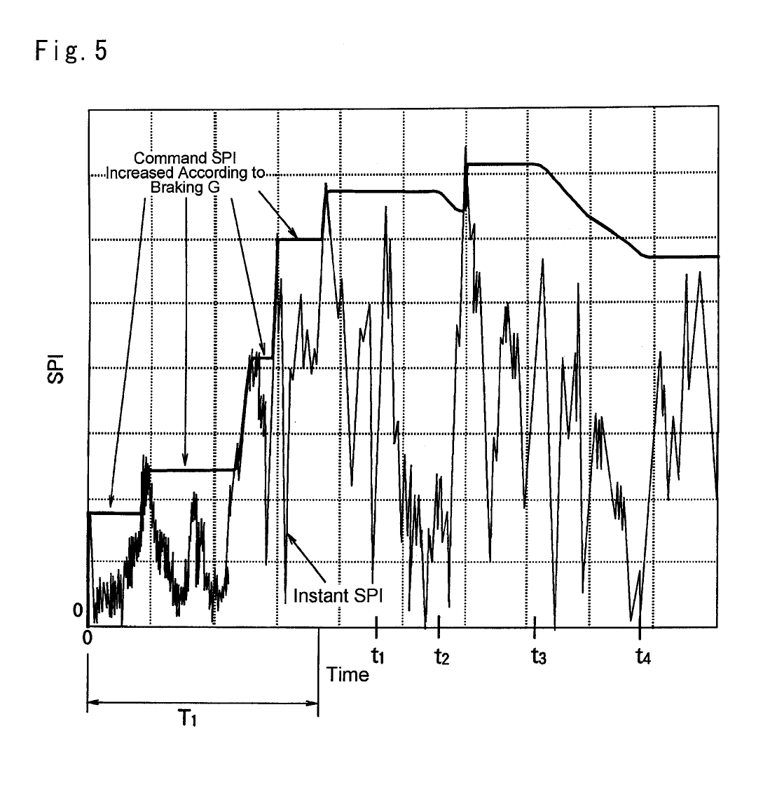

A command SPI to be used in the control for changing a characteristic of the vehicle behavior is obtained on the basis of the above-explained instant SPI. Specifically, the command SPI is increased immediately with an increase of the instant SPI, but lowered after a delay with respect to a drop of the instant SPI. Specifically, the command SPI is lowered upon satisfaction of a specific condition. FIG. 5 is a graph indicating a change in the command SPI calculated based on the instant SPI, under the situation in which acceleration (i.e., a braking G) is generated when braking the vehicle. Specifically, the instant SPI shown in FIG. 5 corresponds to the plotted values indicated in FIG. 4. Meanwhile, the command SPI is set on the basis of a local maximum value of the instant SPI, and the command SPI is maintained until a satisfaction of the predetermined condition. Thus, the command SPI is increased promptly but lowered relatively slower.

Specifically, during a period T1 from a commencement of the control, the instant SPI is fluctuated according to a change in the acceleration resulting from braking the vehicle etc. During the period T1, the instant SPI being fluctuated is increased locally to a maximum value prior to a satisfaction of the predetermined condition to update the command SPI. In this situation, therefore, the command SPI set on the basis of the local maximum value of the instant SPI is increased stepwise. Then, when the condition to lower the command SPI is satisfied at a time point t2 or t3, the command SPI is started to be lowered. That is, the command SPI is lowered in case that maintaining the previous large value of the command SPI is not preferable. Specifically, according to the present invention, such condition to lower the command SPI is satisfied based on an elapsed time.

More specifically, the above-mentioned condition in that “maintaining the previous large value of the command SPI is not preferable” is a situation in which a divergence between the command SPI being maintained to the current value and the instant SPI is relatively large and such divergence between the indexes is being continued. For example, the command SPI will not be lowered even if the instant SPI is lowered instantaneously by an operation not intended to decelerate the vehicle, for example, even if the instant SPI is lowered instantaneously by returning the accelerator pedal 12 temporarily to maintain the vehicle speed after acceleration, or by a habit of the driver. However, in case the instant SPI fluctuates below the command SPI for a certain period of time, the aforementioned condition to lower the command SPI is satisfied. Thus, the length of time in which the instant SPI stays below the command sportiness SPI is used as the condition to start lowering (or changing) the command SPI. In order to reflect the actual driving condition of the vehicle more accurately on the command SPI, a temporal integration (or accumulation) of the deviation between the command SPI and the instant SPI may be used as the condition to lower the command SPI. In this case, the command SPI is lowered when the temporal integration of the deviation between those indexes reaches a predetermined threshold. For this purpose, this threshold may be determined arbitrarily on the basis of result of a driving test or simulation. In case of using the temporal integration as the condition to lower the command SPI, the command SPI is to be lowered taking into consideration a duration time of the divergence of the instant SPI from the command SPI, in addition to the deviation between the command SPI and the instant SPI. Therefore, in this case, the actual driving condition or behavior of the vehicle can be reflected on the control to change the characteristics of the vehicle behavior more accurately.

In the example shown in FIG. 5, a length of time to maintain the command SPI before the time point t2 is longer than a length of time to maintain the command SPI before the time point t3. Those lengths of times to maintain the command SPI are determined by a control to be explained hereinafter. Specifically, as indicated in FIG. 5, the command SPI is increased to a predetermined value at the end of the aforementioned period T1 and maintained. In this situation, the instant SPI rises instantaneously at the time point t1 before the time point t2 at which the condition to lower the command SPI is to be satisfied. Therefore, the deviation between the command SPI and the instant SPI in this situation is smaller than a predetermined value. Here, this predetermined value of the deviation to lower the command SPI may be set arbitrarily on the basis of a result of a driving test or a simulation while taking into consideration a calculation error of the instant SPI. In case the instant SPI is thus raised close to the command SPI being maintained, this means that the actual driving condition of the vehicle at this time point is similar to the accelerating and turning conditions upon which the current command SPI is based. That is, although a certain period of time has elapsed from the time point at which the current commend SPI being maintained was set, the actual driving condition of the vehicle is still similar to the condition at the time point when the current command SPI being maintained is set. Therefore, in this situation, a commencement to lower the command SPI is delayed to maintain the current value of the command SPI even if the instant SPI is fluctuating below the current command SPI being maintained. For example, the commencement to lower the command SPI can be delayed by resetting the elapsed time (i.e., accumulation time) or the integral of deviation from the time point at which the current command SPI was set, and restarting the accumulation of the elapsed time or the integration of the deviation. Alternatively, the commencement to lower the command SPI may also be delayed by subtracting a predetermined value from the elapsed time of the command SPI or the integral of deviation between the command SPI and the instant SPI, or interrupting the accumulation of the elapsed time or the integration of the deviation for a predetermined period of time.

FIG. 6 is a graph indicating the aforementioned integral of the deviation between the command SPI and the instant SPI, and the reset of the integral. In FIG. 6, a shadowed area indicates the integral of the deviation between the command SPI and the instant SPI. In the example indicated in FIG. 6, the reset of the integral of the deviation is executed at the time point t1 at which the divergence between the command SPI and the instant SPI becomes smaller than a predetermined value Δd, and the integration of the deviation therebetween is restarted from the time point t1. Consequently, the condition to lower the command SPI is prevented from being satisfied at the time point t1 even if the command SPI has been maintained for a long time so that the command SPI is maintained to the previous value. Then, when the instant SPI exceeds the command SPI after restarting the integration of the deviation therebetween, the command SPI is updated to the local maximum value of the instant SPI and maintained.

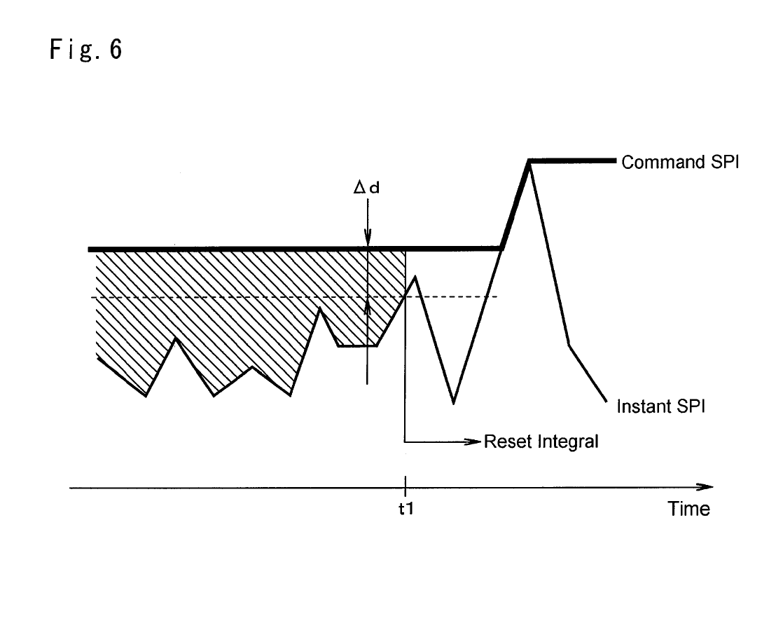

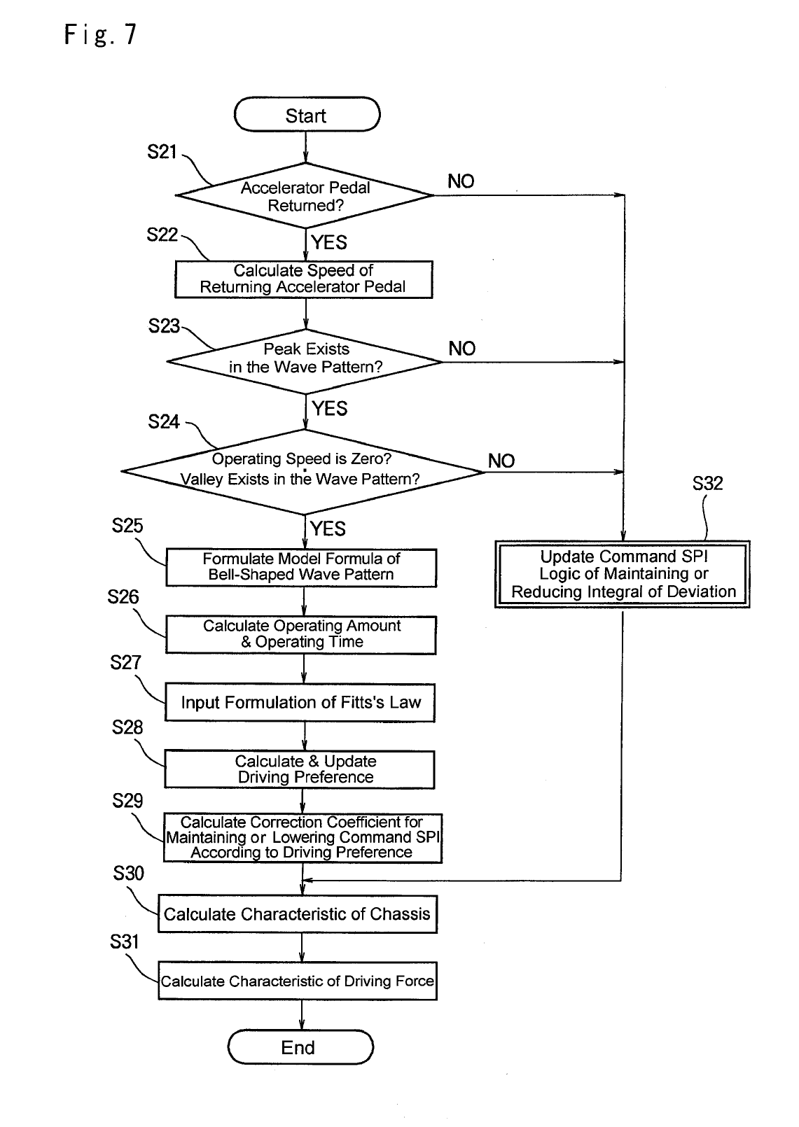

The present invention may be applied to the control for changing the condition to start lowering the command SPI, and an example of such control is shown in FIG. 7. In the control shown in FIG. 7, the accelerator pedal 12 is employed as the handling device. First of all, it is judged whether or not the accelerator pedal is returned (at step S21). Specifically, an operation to return the accelerator pedal 12 can be judged based on a reduction in the detection value of the accelerator opening sensor 20. In case the opening degree of the accelerator is reduced so that the answer of step S21 is YES, a speed of returning the accelerator pedal is calculated (at step S22). As described, the returning speed of the accelerator pedal may be obtained by differentiating a detection value from the accelerator opening sensor 20 with respect to time. Alternatively, the returning speed of the accelerator pedal may be detected by arranging a detection sensor of the operating speed.

Then, a judgment of an existence of a peak (at step 23), a judgment of the zero speed and the valley (at step S24), a formulation of a model formula of the bell-shaped wave pattern (at step S25), a calculation of the operating amount and the operating time (at step S26), an input of the formulation according to Fitts's law (at step S27), and a calculation of the driving preference (i.e., a mind) of the driver (at step S28) are carried out sequentially. Those steps S23 and S24 are substantially identical to steps S16 and S17 shown in FIGS. 2 and 3, and steps S25 to S28 are substantially identical to steps S12 to S15 shown in FIGS. 1, 2 and 3. Therefore, an explanation of those steps S23 to S28 will be omitted.

After calculating the driver's mind (that is, the above-explained constant “a”) at step S28, a correction coefficient for maintaining or lowering the command SPI is calculated based on the calculated value of the driver's mind (at step S29). As described, the command SPI is the index for setting the control characteristics, and the control characteristic is adjusted in a manner to enhance the sportiness of the vehicle in case the command SPI is large. Therefore, in case the mind calculated at step S28 shows a tendency of the driver to drive the vehicle in a sporty manner, the correction coefficient is adjusted in a manner to prevent the maintained command SPI from being lowered. As described, the condition to start lowering the command SPI is satisfied when the duration time that the instant SPI fluctuates below the command SPI exceeds the predetermined threshold, or when the temporal integration (or accumulation) of the deviation between the command SPI and the instant SPI reaches the predetermined threshold. Therefore, in this case, the correction coefficient is adjusted in a manner to prevent those thresholds from being lowered or to increase those thresholds. For this purpose, the correction coefficient may be used to multiply the threshold. Instead, the correction coefficient may also be added to the threshold. To the contrary, in case the driver's mind calculated at step S28 shows a tendency of the driver to drive the vehicle in a mild manner, the correction coefficient is adjusted in a manner to facilitate a reduction of the maintained command SPI. As also described, the condition to start lowering the command SPI is satisfied when the duration time that the instant SPI fluctuates below the command SPI exceeds the predetermined threshold, or when the temporal integration (or accumulation) of the deviation between the command SPI and the instant SPI reaches the predetermined threshold. In this case, therefore, the correction coefficient is adjusted in a manner to reduce the above-mentioned thresholds.

After thus changing the command SPI used to adjust the control characteristic in accordance with the driving preference of the driver, a characteristic of the chassis is calculated (at step S30), and a characteristic of the driving force is calculated (at step S31), on the basis of the command SPI thus changed. Specifically, those characteristics are set arbitrarily by changing characteristics of the throttle valve 10, the transmission 13, the shock absorber 5 of the suspension 4, the assist mechanism 18 and so on by the actuators of those devices. Basically, those control characteristics are changed in a manner to enhance the agility of the vehicle behavior, that is, the sportiness of vehicle according to an increase in the command SPI. Specifically, in case the command SPI is increased, the control characteristics of the vehicle is changed in a manner to generate larger driving force thereby allowing the vehicle to be accelerated quickly, to sustain the vehicle body tightly thereby preventing a depression or bounce of the vehicle, and to reduce an assisting amount of the steering thereby enhancing a direct feeling of the steering. According to the prior art, such adjustment of the control characteristics have been carried out by shifting the driving mode such as a sporty mode, a normal mode etc. using a mode selecting switch.

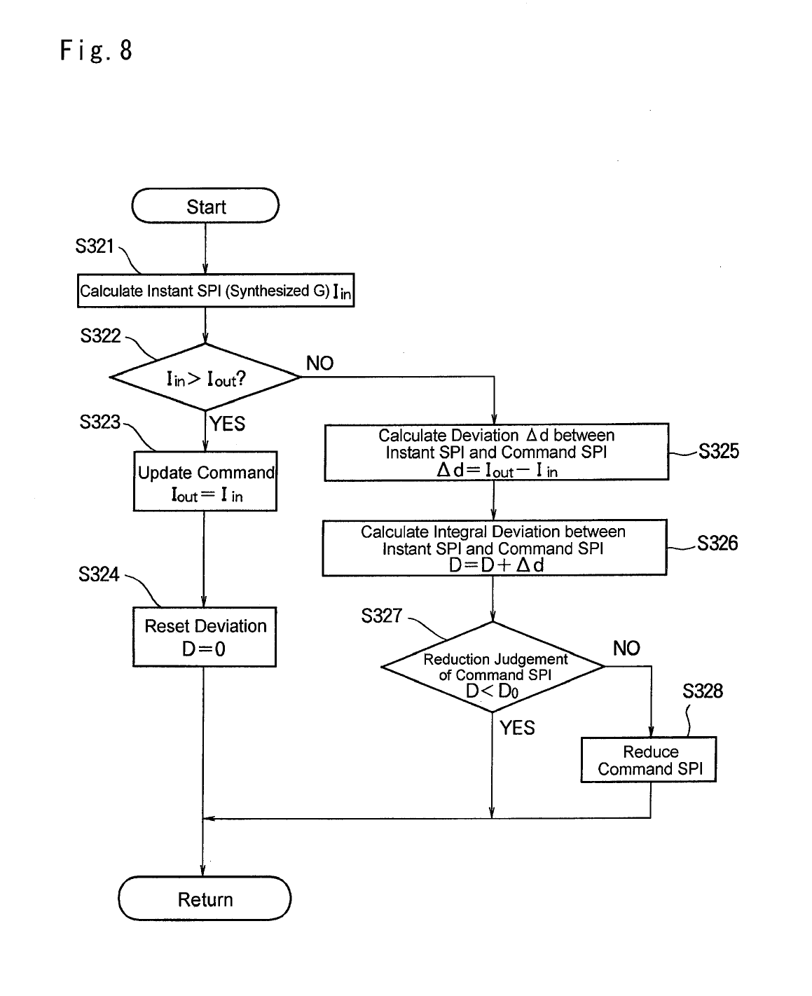

In case the answer of any of the above-explained steps S21, S23 and S24 is NO, the routine advances to step S32 to carry out a control to judge a satisfaction of the condition to start lowering the command SPI. An example of the judgment to start lowering the command SPI based on the aforementioned integral of the deviation will be explained hereinafter. FIG. 8 shows a subroutine of the control carried out at step S32, and first of all, a value Iᵢₙ of the instant SPI, that is, a synthesized acceleration (i.e., a synthesized G) is calculated (at step S321). Then, the value Iᵢₙ is compared with a value Iₒᵤₜ of the command SPI being held (at step S322). In case the value Iᵢₙ of the instant SPI is larger than the value Iₒᵤₜ of the command SPI so that the answer of step S322 is YES, the value Iₒᵤₜ of the command SPI is updated to the value Iᵢₙ of the instant SPI (at step S323). During the period of maintaining the command SPI to the current value of Iₒᵤₜ, a deviation between the Iᵢₙ and Iₒᵤₜ is accumulated. However, when the value Iₒᵤₜ of the command SPI is updated, a reset of an integral of the deviation D is executed (at step S324) and the routine s returned. Specifically, the integral of the deviation D is reset to 0 as expressed by the following equation:

D=0.

To the contrary, in case the answer of step S322 is NO, that is, in case the value Iᵢₙ of the instant SPI is smaller than the value Iₒᵤₜ of the command SPI, a deviation Δd between the value Iₒᵤₜ of the command SPI and the value Iᵢₙ of the instant SPI is calculated (at step S325). Specifically, the deviation Δd is calculated using the following formula:

Δd=Iₒᵤₜ−Iᵢₙ.

Then, an integral of the deviation D between the value Iₒᵤₜ of the command SPI and the value Iᵢₙ of the instant SPI is calculated (at step S326) using the following formula:

D=D+deviation Δd.

Then, it is judged whether or not the integral of the deviation D between the value Iₒᵤₜ of the command SPI and the value Iᵢₙ of the instant SPI is smaller than a reduction starting threshold D0 set in advance (at step S327). Specifically, the reduction starting threshold D0 is used to determine a point of time to start lowering the value Iₒᵤₜ of the command SPI being maintained, in other words, the reduction starting threshold D0 is used to define a length of time for maintaining the current value of Iₒᵤₜ of the command SPI. Therefore, when the integral of the deviation D exceeds the reduction starting threshold D0, a judgment to start lowering the value Iₒᵤₜ of the command SPI is carried out.

In case the integral of the deviation D between the value Iₒᵤₜ of the command SPI and the value Iᵢₙ of the instant SPI is smaller than the reduction starting threshold D0 so that the answer of step S327 is YES, the routine is returned to maintain the value Iₒᵤₜ of the command SPI to the current value. To the contrary, in case the integral of the deviation D between the value Iₒᵤₜ of the command SPI and the value Iᵢₙ of the instant SPI is larger than the reduction starting threshold D0 so that the answer of step S327 is NO, the routine advances to step S328 to lower the value Iₒᵤₜ of the command SPI. In order to reduce uncomfortable feeling of the driver, a manner to lower the value Iₒᵤₜ of the command SPI may be adjusted arbitrarily.

In case of carrying out the control shown in FIG. 8, a calculation of the correction coefficient at step S29 in FIG. 7 is carried out in a manner to adjust the reduction starting threshold D0 according to the driving preference of the driver.

The present invention should not be limited to the examples thus far explained. For example, in the above-explained examples, the control characteristic is changed between the sporty characteristic and the mild characteristic. However, it is also possible to change the control characteristic continuously or steplessly by detecting the driving preference in the form of numerical value to be varied continuously such as the aforementioned constant “a”, and adjusting or setting the control characteristic based on the detected value. In addition, according to the present invention, the “correlation of operational preference” is not necessary to conform to the above-explained Fitts's law accurately. Therefore, a correlation expressed by a modified formulation of Fitts's law may also be used in the present invention.

1. A vehicle control system, which is configured to adjust a control characteristic of a vehicle in accordance with a driving preference of a driver, wherein:
an intentional operation of the driver is detected based on a pattern of a change in a speed of an operation carried out by the driver to change a driving condition of the vehicle; and
the driving preference is judged on the basis of: a correlation of operational preference determining a correlation among an operating amount, an operating time and an operating preference in advance; an operating amount of the intentional operation; and an operating time of the intentional operation.

2. The vehicle control system as claimed in claim 1, wherein the correlation of operational preference includes a correlation among the operating amount, the operating time and the operating preference determined using a formulation according to Fitts's law.

3. The vehicle control system as claimed in claim 1,
wherein the control characteristic includes a sporty characteristic where a behavior of the vehicle is changed quickly by the operation of the driver, and a mild characteristic where the behavior of the vehicle is changed milder in comparison with that under the sporty characteristic, and
the vehicle control system comprises:
a device adapted to set an index, which enhances sportiness of the control characteristic in case an absolute value of synthesized acceleration of at least longitudinal acceleration and lateral acceleration is large in comparison with a case in which the absolute value of the synthesized acceleration is small, which is changed in a manner to enhance the sportiness in case the absolute value of the synthesized acceleration is increased, and which is maintained to a current value thereof until a satisfaction of a predetermined condition in case the absolute value of the synthesized acceleration is lowered; and
a device adapted to change the predetermined condition based on the driving preference which is judged based on the pattern of a change in the speed of the intentional operation.

4. The vehicle control system as claimed in claim 3, wherein:
the predetermined condition is prevented from being satisfied in case the driving preference judged based on the pattern of a change in the speed of the intentional operation shows a tendency conforming to a behavior of the vehicle under the sporty characteristic; and
the predetermined condition is facilitated to be satisfied in case the driving preference judged based on the pattern of a change in the speed of the intentional operation shows a tendency conforming to a behavior of the vehicle under the mild characteristic.

5. The vehicle control system as claimed in claim 1, wherein the control characteristic includes at least any one of:
a characteristic to change a driving force based on an accelerating operation or a decelerating operation of the vehicle; and
a characteristic to change a turning angle based on a steering operation.

6. The vehicle control system as claimed in claim 2,
wherein the control characteristic includes a sporty characteristic where a behavior of the vehicle is changed quickly by the operation of the driver, and a mild characteristic where the behavior of the vehicle is changed milder in comparison with that under the sporty characteristic, and
the vehicle control system comprises:
a device adapted to set an index, which enhances sportiness of the control characteristic in case an absolute value of synthesized acceleration of at least longitudinal acceleration and lateral acceleration is large in comparison with a case in which the absolute value of the synthesized acceleration is small, which is changed in a manner to enhance the sportiness in case the absolute value of the synthesized acceleration is increased, and which is maintained to a current value thereof until a satisfaction of a predetermined condition in case the absolute value of the synthesized acceleration is lowered; and
a device adapted to change the predetermined condition based on the driving preference which is judged based on the pattern of a change in the speed of the intentional operation.

7. The vehicle control system as claimed in claim 2, wherein the control characteristic includes at least any one of:
a characteristic to change a driving force based on an accelerating operation or a decelerating operation of the vehicle; and
a characteristic to change a turning angle based on a steering operation.

8. The vehicle control system as claimed in claim 3, wherein the control characteristic includes at least any one of:
a characteristic to change a driving force based on an accelerating operation or a decelerating operation of the vehicle; and
a characteristic to change a turning angle based on a steering operation.

9. The vehicle control system as claimed in claim 4, wherein the control characteristic includes at least any one of:
a characteristic to change a driving force based on an accelerating operation or a decelerating operation of the vehicle; and
a characteristic to change a turning angle based on a steering operation.

10. The vehicle control system as claimed in claim 6, wherein the control characteristic includes at least any one of:
a characteristic to change a driving force based on an accelerating operation or a decelerating operation of the vehicle; and
a characteristic to change a turning angle based on a steering operation.
